(19) United States
(12) Patent Application Publication
(10) Pub. No.: US 2016/0348205 A1
(43) Pub. Date: Dec. 1, 2016

(54) METHOD FOR RESTORING THE STRUCTURE OF A STEEL COMPONENT AFTER HEATING AND STEEL COMPONENT OBTAINED BY THE METHOD

(71) Applicant: Aktiebolaget SKF, Goteborg (SE)

(72) Inventor: Staffan LARSSON, Goteborg (SE)

(73) Assignee: Aktiebolaget SKF, Goteborg (SE)

(21) Appl. No.: 15/163,640

(22) Filed: May 24, 2016

(30) Foreign Application Priority Data
May 25, 2015 (SE) 1550664-5

(51) Int. Cl. C21D 9/40; C22C 38/60; C22C 38/50; C22C 38/44; C22C 38/42; C22C 38/06; C22C 38/04; C22C 38/02; C22C 38/00; C21D 8/00; C21D 1/32; C21D 1/84; C21D 1/613; C21D 1/60; B23K 11/04

(52) U.S. Cl. CPC C21D 9/40; B23K 11/04; C22C 38/60; C22C 38/50; C22C 38/44; C22C 38/42; C22C 38/06; C22C 38/04; C22C 38/02; C22C 38/002; C22C 38/001; C21D 8/005; C21D 1/32; C21D 1/84; C21D 1/613; C21D 1/60; C21D 2211/008

(57) ABSTRACT

The present disclosure relates to a method for restoring the steel structure of a steel component after heating the steps of heating the steel component to a temperature of at least 1100° C., quenching the steel component to a temperature above the martinsite start temperature (Ms), and maintaining the steel component at that temperature for a holding time sufficient for transformation of all austenite, re-heating the steel component to a temperature of 950 to 1110° C., quenching the steel component to a temperature above the martensite start temperature (Ms), and maintaining the steel component at that temperature for a holding time sufficient for transformation of all austenite, re-heating the steel component to a temperature of above the Ac₁ transformation temperature and below 800° C., and maintaining the steel component at that temperature for a holding time sufficient for inititation and completion of spheroidization, and cooling the steel component when the spheroidization is completed, and maintaining a cooling rate of 20° C./h or below during cooling from the Ar₃ transformation temperature and until the Ar₁ transformation temperature is reached.

### TECHNICAL FIELD

This disclosure pertains to a method for restoring a steel structure for a steel component after heating and a steel component obtained by the method.

### BACKGROUND

Steel components, such as bearing components, are subjected to stringent demands with respect to strength, length of use and microstructural stability against aging. These steel components require a material that in the machined state has a homogenous microstructure with very finely distributed globular carbides.

During production of bearing components the components are heated to high temperatures, such as during welding, hot rolling and forging of tubes and bars, hot drawing of wires and hot rolling and forging of rings. After the heating steps the resulting steel components are often collected and left to cool. When heated to such high temperatures the microstructure of the steel becomes affected. Also, the conditions during the subsequent cooling will impact the microstructure of the steel. When collected and left to cool together, the components may cool down at different cooling rates, leading to inhomogeneous microstructures between the components. For the components having cooled down slowly, grain boundary cementite may have formed and for components allowed to cool more rapidly there is a risk of martensite formation. In order to restore and normalize the microstructure of the heated and subsequently cooled rings the rings need to be re-annealed. The annealing of such rings may take considerable time, such as between 24 hours and 48 hours.

Flash-butt welding, or “flash welding” is a resistance welding technique for joining segments of metal, such as a steel components, in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two surfaces to be welded, an upset force is applied to complete the weld. This upset force extrudes slag, oxides and molten metal from the weld zone, leaving a welding accretion in the colder zone of the heated metal. The joint is then allowed to cool slightly before the clamps are opened to release the welded article. The welding accretion may be left in place or removed by shearing while the welded article is still hot, or by grinding, depending on the requirements. Although flash butt welding is a simple and efficient welding technique, the physical properties of a component in the vicinity of its weld joint(s) may be adversely affected by the flash butt welding, because of defects, such as weld/quench cracks, which occur during and after the flash butt welding, and since the microstructure of the steel in a heat affected zone (HAZ) around a weld joint will be modified by the flash butt welding.

### SUMMARY

One object of the present disclosure is to provide an effective and time-saving method for restoring a steel structure after heating to high temperatures, such as after welding, hot rolling and forging of tubes and bars, hot drawing of wires and hot rolling and forging of rings, to provide a steel component, such as a bearing component, having restored microstructure and thus a correct hardened microstructure in order to arrive at improved wear resistance, such as improved rolling contact fatigue properties. Furthermore, since the method according to the present disclosure may be performed in-line with the heating step, the energy resulting from the first heating step may be utilized during the subsequent restoration steps, resulting in savings in terms of energy consumption.

This object is achieved by a method for restoring a steel structure after heating according to claim 1.

As such, the present disclosure relates to a method for restoring the steel structure of a steel component after heating comprising the steps of; a) heating the steel component to a temperature of at least 1100° C., b) quenching the steel component to a temperature above the martinsite start temperature (Ms), and maintaining the steel component at that temperature for a holding time sufficient for transformation of all austenite, c) re-heating the steel component to a temperature of 950 to 1110° C., d) quenching the steel component to a temperature above the martensite start temperature (Ms), and maintaining the steel component at that temperature for a holding time sufficient for transformation of all austenite, e) re-heating the steel component to a temperature of above the Ac₁ transformation temperature, i.e. the onset temperature of ferrite to austenite formation, and below 800° C., and maintaining the steel component at that temperature for a holding time sufficient for inititation and completion of spheroidization, f) cooling the steel component when the spheroidization is completed, and maintaining a cooling rate of 20° C./h or below during cooling from the Ar₃ transformation temperature, i.e. the temperature of onset of austenite to ferrite transformation, and until the Ar₁ transformation temperature, i.e. the temperature of complete transformation of all austenite to ferrite, is reached.

Optionally, step a) may comprise forming the steel component by hot rolling, forging and/or hot drawing at a temperature of at least 1100° C.

Optionally, step a) may comprise welding the steel component at a temperature of at least 1100° C. to form a welding joint, wherein the welding joint optionally may be a flash-butt welded joint.

Optionally, step b) may comprise quenching the steel component to a temperature above Ms and below 450° C., and maintaining the steel component at that temperature for a holding time sufficient for transformation of all austenite.

Optionally, step d) may comprise quenching the steel component to a temperature above Ms and below 450° C., and maintaining the steel component at that temperature for a holding time sufficient for transformation of all austenite.

Optionally, step e) may comprise re-heating the steel component to a temperature of above 765° C. and below 800° C., and maintaining the steel component at that temperature for a holding time sufficient for inititation and completion of spheroidization.

Optionally, step f) may comprise cooling the steel component, when the spheroidization is completed, from the Ar₃ transformation temperature and until the Ar₁ transformation temperature whilst maintaining a cooling rate of from 20° C./h to 10° C./h.

Optionally, the method comprises a further step g), after step f), of holding the steel component for a sufficient time to allow equalization of the temperature throughout the entire steel component.

Optionally, the steel component is a high-carbon steel component.

Optionally, the steel component is a bearing component, such as a bearing ring.

The present disclosure also concerns a steel component that is manufactured using a method according to any aspects of the invention. The present disclosure also concerns a steel component comprising a welding joint, such as a flash butt welded joint, which is manufactured using a method according to any of the aspects of the disclosure. Optionally, the steel component may be a bearing ring, for use in a bearing, such as a roller bearing, a needle bearing, a tapered roller bearing, s spherical roller bearing, a tyroidal roller bearing, a thrust bearing or a bearing for any application in which it is subjected to alternating Hertzian stresses, such as rolling contact or combined rolling and sliding. The bearing may for example be used in automotive, wind, marine, metal producing or other machine applications which require high wear resistance and/or increased fatigue and tensile strength.

### BRIEF DESCRIPTION OF THE DRAWINGS

The present disclosure will hereinafter be further explained by means of non-limiting examples with reference to the appended schematic figures herein;

FIG. 1 shows a method according to one embodiment of the present disclosure.

FIG. 2 shows an open ring clamped to be flash butt welded according to one embodiment of the present disclosure.

FIG. 3 shows a bearing according to one embodiment of the present disclosure.

### DETAILED DESCRIPTION

During production of bearing components by welding, hot rolling and forging of tubes and bars, hot drawing of wires and hot rolling and forging of rings the steel is heated to high temperatures, such as above about 1200° C. The components resulting from these metal forming processes are subsequently normally collected in, for example, a container and left to cool.

When heated to such high temperatures, the microstructure of the steel is affected, and also the cooling rate for the steel will affect the microstructure. When left to cool together, the components may cool down at different cooling rates leading to inhomogeneous microstructures between the components. For the components having cooled down slowly, grain boundary cementite may have formed and for components allowed to cool, more rapidly there is a risk of martensite formation, both cases leads to undesired microstructure.

When forming high carbon steel, which is suitable in for example bearing components 7,8, 9 such as bearing rings 7,8, the steel needs to be in soft annealed condition to avoid cracking. This implies a fine-grain homogenous microstructure of the steel comprising spheroidised carbides. In order to restore and normalize the microstructure of the heated and subsequently cooled components the components need to be annealed. The annealing of such components may take considerable time, such as between 24 hours and 48 hours. This annealing process including re-heating of the steel components results in high energy consumption.

By “high carbon steel” herein is meant a carbon steel with a carbon content of about 0.6 weight % or higher, such as about 0.6 to about 1.20 weight %, such as about 0.8 to about 1.20 weight %. The high carbon bearing steel may be 100Cr6/SAE52100 and 100CrMo7-4 from AB SKF.

Optionally, the steel may have the following composition in weight %:

| | |
|---|---|
| C | 0.6-1.2 |
| Si | 0-0.25 |
| Mn | 0.1-1.0 |
| Cr | 0.01-2.2 |
| Mo | 0.01-1.0 |
| Ni | 0.01-2.0 |
| S | 0-0.002 |
| P | 0-0.010 |
| Cu | 0-0.45 |
| Al | 0.010-1.0 |
| As | 0-0.1 |
| Pb | 0-0.01 |
| Ca/Pb/Ti/N/H | 0-0.0001 |

balance Fe and normally occurring impurities.

Annealing is a well-known heat treatment method that alters the physical properties of the material, steel herein, to increase its ductility and to make it more workable. It involves heating a material to above its glass transition temperature, maintaining a suitable temperature, and then cooling. Annealing can induce ductility, soften material, relieve internal stresses, refine the structure by making it homogeneous, and improve cold working properties.

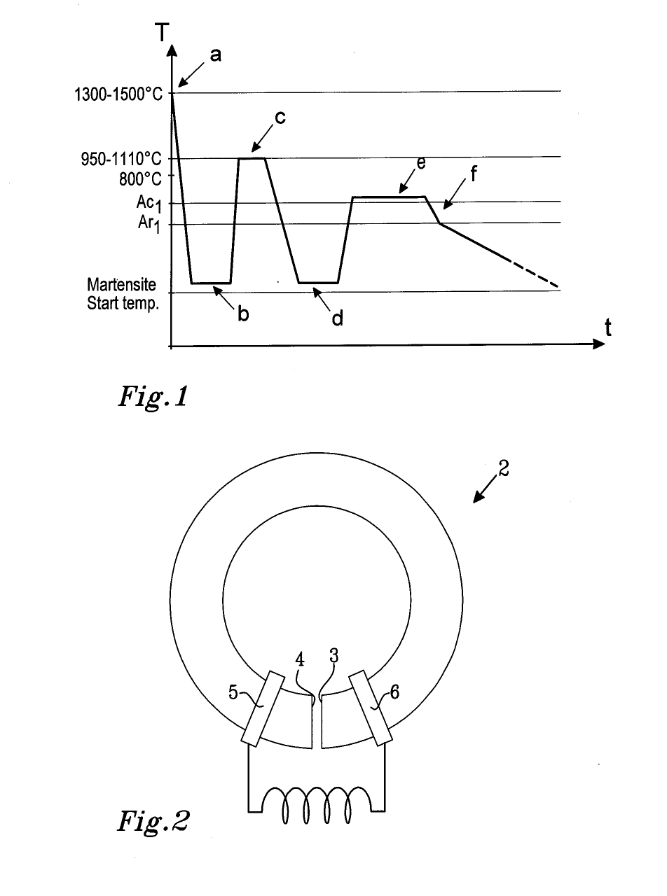

FIG. 1 shows a method according to the present disclosure. The method comprises the steps a) of heating a steel component to a temperature of at least 1100° C., such as at least 1200° C. Instead of letting the components cool down to about room temperature the steel components may directly be subjected to a method comprising the steps b) to f). Subjecting the steel components directly to these method steps has been found to completely restore the microstructure of the steel components and give a correct hardened microstructure in a cost efficient in-line method. The method according to the present disclosure thus comprises a further step b), wherein the steel components are subjected to quenching, to a temperature above the martensite start temperature (Ms), such as 10 to 20° C. above the Ms temperature, and maintained at that temperature for a holding time sufficient for transformation of all austenite, to bainite or perlite. This step is thus the starting step for the restoration of the microstructure of the steel components. The purpose of this step is to avoid formation of martensite and start to regain the desired microstructure. This step b) may also comprise quenching the steel to a temperature above Ms and below 450° C. In this temperature interval the risk of formation of perlite is greatly reduced. To further minimize the risk of grain boundary cementite step b) may comprise quenching the steel components to a temperature of 300 to 350° C. However, the restoration of the microstructure may also take place when Pearlite is formed, which occurs between about 450 and 600° C. This step may be carried by means of a fluidized bed, immersion in a salt bath, in liquid nitrogen or in air vapour or the like.

One purpose with this quenching step is thus to avoid formation of grain boundary cementite. This may also be ensured by quenching the steel components at a cooling rate fast enough to avoid grain boundary cementite, as may be determined by reference to a CCT diagram. The CCT diagram may have been previously prepared, stored in a database, or otherwise made available for control of the cooling rate. CCT diagrams may of course also be prepared and used for determining the temperatures and cooling rates to apply during the quenching and heating steps.

To detect and determine when a transformation of all austenite into bainite has been completed the skilled person may use a dilatometer. Dilatometry is an experimental technique that allows the solid state phase transformations occurring in different materials, particularly steels, to be detected and followed. Phase transitions bring about volume changes, and these changes can be recorded by studying the length changes of samples with normalized dimensions during their heating or cooling. The variations in the rate and direction of length change versus temperature (dilation/contraction) allow the temperatures at which phase transformations of steel take place to be determined.

When the desired cooling has been achieved, the steel components may be transferred to a furnace for isothermal hold at a temperature in the range of 150-260° C. The aim is for the steel components to reach a temperature of around 320° C. and maintain this temperature for around 2 hours, such as at least 1.5 hours. The purpose with this is to ensure complete transformation of all the austenite to bainite, but also to facilitate the handling of the steel components and to avoid to high furnace temperatures when loading the steel components.

The method furthermore comprises the step c) of re-heating the steel components to a temperature of about 950 to about 1110° C. This step will normalize the grain size, to obtain the desired steel strength, and dissolve undesired primary carbides (formed from Chromium, Molybdenum and Manganese) formed during welding and subsequent cooling. When cooling and subsequently re-heating the steel components primary carbides are formed, these have a small grain size which is not preferred for a restored microstructure. The steel components are subsequently quenched in step d) to a temperature above the martensite start temperature (Ms), such as 10 to 20° C. above the Ms temperature, and maintained at this temperature for a sufficiently long time to transform all austenite, to form bainite and/or perlite. This step d) may also comprise quenching the steel components to a temperature above Ms and below 450° C. In this latter temperature interval bainite is formed, which reduces the risk of grain boundary cementite and renders the restoration easier and faster. To even further minimize the risk of grain boundary cementite step d) may comprise quenching the steel components to a temperature of 300 to 350° C. The quenching may be carried out in a fluidized bed, by immersion in a salt bath, in liquid nitrogen or in air vapour or the like. Through this step the grains have retrieved their proper size of about 10-20 μm and grain boundary cementite is also avoided. It is furthermore ensured that no perlite, i.e. interlamellar spacing structure, remains to weaken the structure.

The method according to the present disclosure then comprises step e), wherein the steel components are re-heated to a temperature of above the Ac₁ transformation temperature and below 800° C., and maintained at that holding time sufficient for initiation and completion of spheroidization. This may for example take place at temperatures above about 765° C. and below 800° C. If the steel components would be re-heated to above 800° C., manganese may be released from the carbides, which slows down the process. Furthermore, when re-heating the steel components to temperatures above 800° C., perlite may be formed, which, as explained above, may weaken the structure. The time it takes to heat a steel component is about 1 minute per mm thickness of the component.

Spheroidizing is a heat treatment during which perlite in the steel structure is converted to spheroidal form. This heating process takes approximately one to three hours. The completion of the spheroidization results in a lowering of the tensile strength of the steel ring 1, and an increase of the ductility. The lowered tensile strength and the increase in ductility are the results of the spheroidizing or coalescing of the carbides in the undesirable hard microconstituents.

To assess the degree of spheroidization of the steel the standard method SEP 1520 (3rd edition) may be used. In this standard method, microspecimen are observed under a microscope and visually compared and graded against series of diagram which contain a characteristic feature of the carbide structure. The series to be used for this assessment is Series 3, and when the sample compared corresponds to a grade of 3.0, the spheroidization of the steel is considered to be completed. When the spheroidization is completed the steel components should be removed directly from the source of heat and the next step f) should be initiated. If the steel components continuously are heated until a sample taken from a steel component corresponds to a grade 3.1 according to the standard method SEP 1520, the resulting steel would be associated with a risk of crack formation during cold forming of the steel component.

The time required for achieving initiation and completion of a spheroidizing process is normally around 1 to 3 hours in this temperature interval for high-carbon steel rings. However, the rate of dissolution of the perlite lamellae into spheroids may also depend on the surrounding conditions.

With “Ac₁ transformation temperature” is meant herein the onset temperature of ferrite to austenite formation.

This step e), has been found to allow diffusion of the carbides and the resulting microstructure of the steel components is a microstructure of fine spherical particles in a soft ferritic matrix. The main purpose with this step is to reduce the hardness of the steel material and to completely restore the initial microstructure of the steel components.

According to the subsequent cooling step f), which is initiated directly after the spheroidization is completed, a cooling rate of 20° C./h or below is maintained during the cooling of the steel components when the temperatures are ranging between the Ar₃ transformation temperature and the Ar₁ transformation temperature, to ensure a homogenous carbide distribution and that the desired microstructure is maintained. The cooling rate may also be from 20° C./h to 10° C./h when the temperature of the steel components ranges between these transformation temperatures. In an optional subsequent step g) the temperature surrounding the steel components is held for a sufficient time to allow equalization of the temperature throughout the entire steel components. After this final step, the steel components may be cooled to room temperature by any desired type of cooling, such as air cooling.

With “Ar₃ transformation temperature” is meant herein the onset temperature of austenite to ferrite transformation and with “Ar₁ transformation temperature” is meant the temperature of complete transformation of all austenite to ferrite.

The properties of the resulting steel components, such as steel bearing components, have been found to be completely homogenous between the steel components and also completely restored to the initial soft annealed condition having a Brinell hardness number of about 200 HB 10/3000 as measured by the test method ASTM E10-12: Standard method for Brinell hardness of metallic materials. This thus leads to improved wear resistance, such as improved rolling contact fatigue properties and thus a prolonged bearing life and also a secured even quality between the components.

Furthermore, the restoration method according to the present disclosure takes around 8 hours for a 60 mm component compared to a conventional annealing process taking 24 to 48 hours for the same component. The present invention has a further advantage in that the restoration method may be carried out in-line with the heating process, and may thus use some of the energy produced during this process instead of the energy being lost by conversion into heat.

One way of manufacturing bearing components 7,8,9, such as bearing rings 7,8 includes flash butt welding. Soft annealed steel plates are then, for example, rolled and bended in a rolling machine to form open bearing rings 2. When forming high carbon steel, which is suitable in bearing components, the steel needs to be in soft annealed condition to avoid cracking. This implies a fine-grain homogenous microstructure of the steel comprising spheroidised carbides. The ends 3,4 of the open bearing rings 2 may be flash butt welded together to form a bearing ring 7,8.

When flash butt welding an open ring 2, as shown in FIG. 2, the ring is clamped near the ends 3,4 that are to be welded, using two clamping electrodes 5,6, and the ends 3,4 are then brought together until they meet, making light contact, and form a flash butt welding joint. While the ring in general is heated to about 200° C. during welding, the heat formed at the welding joint, between the clamps, is about 1300 to about 1500° C. The microstructure of the resulting steel ring 7,8 in the area between the logs, heat affected zone (HAZ), is thus affected and the properties of the steel component 1 in the HAZ are deteriorated. For a bearing ring 7,8 the rolling contact fatigue properties of this zone are inadequate.

It has been found that if subjecting the steel components after welding, such as flash-butt welding, to a method according to the present disclosure comprising the steps b) to f), the microstructure of the steel components in the heat affected zone becomes completely restored to the initial soft annealed condition having a Brinell hardness number of about 200 HB 10/3000, leading to improved wear resistance, such as improved rolling contact fatigue properties and thus an prolonged bearing life.

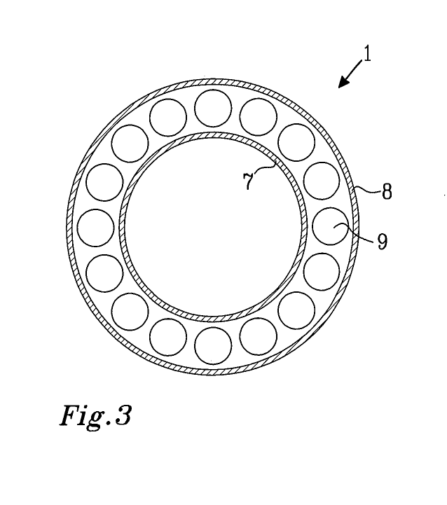

FIG. 3 shows an example of a bearing 1, namely a rolling element bearing that may range in size from 10 mm diameter to a few metres diameter and have a load carrying capacity from a few tens of grams to many thousands of tonnes. The bearing 1 according to the present disclosure may namely be of any size and have any load-carrying capacity. The bearing 1 has an inner ring 7 and an outer ring 8, one or both which may be constituted by a ring according to the present disclosure, and a set of rolling elements 9.

1. A method for restoring a steel structure for a steel component after heating characterized in that it comprises the steps of:
a) heating a steel component to a temperature of at least 1100° C.,
b) quenching the steel component to a temperature of above the martensite start temperature (Ms), and maintaining the steel component at that temperature for a holding time sufficient for transformation of all austenite,
c) re-heating the steel component to a temperature of 950 to 1110° C.,
d) quenching the steel component to a temperature of above the martensite start temperature (Ms), and maintaining the steel component at that temperature for a holding time sufficient for transformation of all austenite,
e) re-heating the steel component to a temperature of above Ac₁ transformation temperature and below 800° C., and maintaining the steel component at that temperature for a holding time sufficient for initiation and completion of spheroidization,
f) cooling the steel component when the spheroidization is completed, and maintaining a cooling rate 20° C./h or below during cooling from the Ar₃ transformation temperature and until the Ar₁ transformation temperature is reached.

2. Method according to claim 1, characterized in that step a) comprises forming the steel component by hot rolling, forging and/or hot drawing at a temperature of at least 1100° C.

3. Method according to claim 1, characterized in that step a) comprises welding the steel component at a temperature of at least 1100° C. to form a welding joint

4. Method according to claim 3, characterized in that the welding joint is a flash butt welded joint.

5. Method according to claim 1, characterized in that step b) comprises quenching the steel component to a temperature above Ms and below 450° C., and maintaining the steel component at that temperature for a holding time sufficient for transformation of all austenite.

6. Method according to claim 1, characterized in that step d) comprises quenching the steel component to a temperature above Ms and below 450° C., and maintaining the steel component at that temperature for a holding time sufficient for transformation of all austenite.

7. Method according to claim 1, characterized in that step e) comprises re-heating the steel component to a temperature of above 765° C., and maintaining the steel component at that temperature for a holding time sufficient for initiation and completion of spheroidization.

8. Method according to claim 1, characterized in that step f) comprises cooling the steel component at a cooling rate of between 10-20° C./h.

9. Method according to claim 1, characterized in that the method, after step f), comprises a further step g) of holding the steel component for a sufficient time to allow equalization of the temperature throughout the entire steel component.

10. Method according to claim 1, characterized in that the steel component is a high-carbon steel component.

11. Method according to claim 1, characterized in that the steel component is a bearing component.

12. Method according to claim 12, characterized in that the bearing component is a bearing ring.

13. Steel component characterized in that it is manufactured using a method for restoring a steel structure for a steel component after heating characterized in that it comprises the steps of
(a) heating a steel component to a temperature of at least 1100° C.,
(b) quenching the steel component to a temperature of above the martensite start temperature (Ms), and maintaining the steel component at that temperature for a holding time sufficient for transformation of all austenite,
(c) re-heating the steel component to a temperature of 950 to 1110° C.,
(d) quenching the steel component to a temperature of above the martensite start temperature (Ms), and maintaining the steel component at that temperature for a holding time sufficient for transformation of all austenite,
(e) re-heating the steel component to a temperature of above Ac₁ transformation temperature and below 800° C., and maintaining the steel component at that temperature for a holding time sufficient for initiation and completion of spheroidization,
(f) cooling the steel component when the spheroidization is completed, and maintaining a cooling rate 20° C./h or below during cooling from the Ar₃ transformation temperature and until the Ar₁ transformation temperature is reached.

14. Steel component according to claim 13, characterized in that it is a steel ring.

15. Steel ring according to claim 14, characterized in that it is a bearing ring.
